(19) United States
(12) Patent Application Publication
(10) Pub. No.: US 2007/0102504 A1
(43) Pub. Date: May 10, 2007

(54) Method for deterring the manufacture, sale and distribution of counterfeit goods

(76) Inventor: Harvey Cohen, Encino, CA (US)

Correspondence Address: KLEINBERG & LERNER, LLP, 2049 CENTURY PARK EAST, SUITE 1080, LOS ANGELES, CA, 90067, US

(21) Appl. No.: 11/531,640

(22) Filed: Sep. 13, 2006

Related U.S. Application Data
(63) Continuation-in-part of application No. 60/716,619, filed on Sep. 13, 2005.

(51) Int. Cl. G06F 17/00; G05B 19/00

(52) U.S. Cl. 235/375; 340/5.8

(57) ABSTRACT

A method for deterring the manufacture, sale or distribution of counterfeit consumer goods is disclosed. Periodically-updated indicia of authenticity of products are provided to the consumer of the product. These periodic updates occur with sufficient frequency to deter counterfeiters and purchasers of counterfeit products in that it will be readily apparent that the goods are counterfeit. Furthermore, the method of this invention is significantly less expensive to implement than prior art methods.

This invention claims priority as a continuation-in-part of the U.S. Provisional Patent application 60/716,619 filed Sep. 13, 2005 entitled Method for Detecting the Manufacture of Counterfeit Consumer Goods.

1. Field of the Invention

The present invention relates to consumer goods and more particularly to a method of deterring the manufacture, sale and distribution of counterfeit consumer goods utilizing a unique and frequently-updated tag for a particular consumer good.

2. Background of the Invention

There are a plethora of consumer goods which are manufactured each year which are counterfeits of highly-desirable designer goods. Each year, millions of dollars are made by counterfeiters manufacturing these designer and other goods and selling them to consumers. Each of those counterfeit goods sold is a potential legitimate customer of the non-counterfeit good. Previously, counterfeit goods were more easily discovered through the counterfeiters use of poor quality materials and lesser workmanship. More modernly, counterfeiters may even be the manufacturer of the good in another country who was hired to create the original good. The counterfeiter simply makes additional units, using the same machinery, the same employees and sometimes even the same outlet for the goods. Modern consumers are largely unable to distinguish between counterfeit goods and original or actual goods manufactured in this or similar ways.

There are very few viable methods whereby a consumer or manufacturer of those goods will be able to determine whether or not those goods are counterfeit. Previously, designers would change the style of goods often or put issue numbers stamped on the goods. Alternatively, they would provide some certificate of authenticity along with the good. Changing the style of the good often incurs significant costs in retooling manufacturers and securing additional new materials and advertising. Stamping a number on specific goods or largely equivalent process may also be mimicked by the counterfeiter. Finally, providing some certificate or other indication of authenticity may also be faked by a savvy counterfeiter. There currently exist no significant legitimate means to combat counterfeit consumer goods. Prestige goods in particular lose their cachet if they are indistinguishable from counterfeits.

This invention improves on the prior art by providing a method whereby the manufacturer may maintain a constantly updated “tag” or other indication that is periodically sent to the owner of an original or non-counterfeit product. This tag or other indication will change often enough to ensure that counterfeiters will have a difficult time keeping up. It overcomes the limitations of the prior art by being significantly less expensive than changing entire designs of goods, placing the control over the tags in the hands of the designer, as opposed to the manufacturer of the goods in a, typically, overseas factory and by providing an obvious and distinctive means by which a consumers, retailer and other members of the public may tell which goods are legitimate and which goods are counterfeit.

### BRIEF SUMMARY OF THE INVENTION

According to the present invention, a method is described whereby the manufacture, sale and distribution of counterfeit goods may be deterred. This invention places the designation of legitimate or counterfeit goods back into the hands of the designer of the product. The designer creates tags, which are commonly used in many industries, which are changed periodically for new, updated tags. These tags are uniquely designed and because they change over time, the products themselves need not be updated as often.

An owner of a legitimate product will register that product with the designer of the product. Thereafter, the designer will provide to the owner updated tags for use with that product to designate that the product is legitimate (non-counterfeit). This saves money in redesigning products or otherwise counteracting counterfeiting for the designer and allows the owner of the legitimate product to know that their product is legitimate.

The method of this invention puts the control back into the designer's hands and back into the hands of everyone involved in the sale and manufacture of legitimate goods. Consumers benefit in that they can be assured that the product they are purchasing is legitimate and that the public will recognize the authenticity of the product, which will cause the product to retain its cachet.

### BRIEF DESCRIPTION OF THE DRAWINGS

FIG. 1 is a depiction of an example supply chain for a product as it moves from the designer to the consumer.

FIG. 2 is a depiction of an example product, a purse, which uses typical mechanisms to counteract counterfeiting.

FIG. 3 is a depiction of an example product, a purse, using the method of this invention to counteract counterfeiting.

FIG. 4 is a depiction of example tags for use with an example product, a purse, to counteract counterfeiting using the method of this invention.

### DETAILED DESCRIPTION OF THE INVENTION

Purchasers of various types of consumer products, particularly more expensive consumer products, are inundated with counterfeit goods. These goods range from relatively equal quality down to terrible quality and craftsmanship. The counterfeit goods are most often made by companies seeking to “play off” the good name of another legitimate product. Typically, these counterfeiters are simply other companies, but in the most nefarious schemes, the counterfeiters are the contracted manufacturers themselves, using the same materials, workers and designs. These counterfeit goods in particular are virtually impossible to detect and can cost the designer hundreds or thousands of dollars per counterfeit item sold.

Counterfeiting can occur at any point along the supply chain of a product. The more expensive or the better name a product has, the more likely that product is to be counterfeited at multiple points along the supply chain. The method of this invention provides the means to counteract counterfeiting at each of the points along the supply chain providing a means of direct interaction between the designer and the owner of the product. This will discourage counterfeiting because the counterfeiters will not be able to obtain the updated tags for their goods and they will shortly be outdated and obvious as counterfeit.

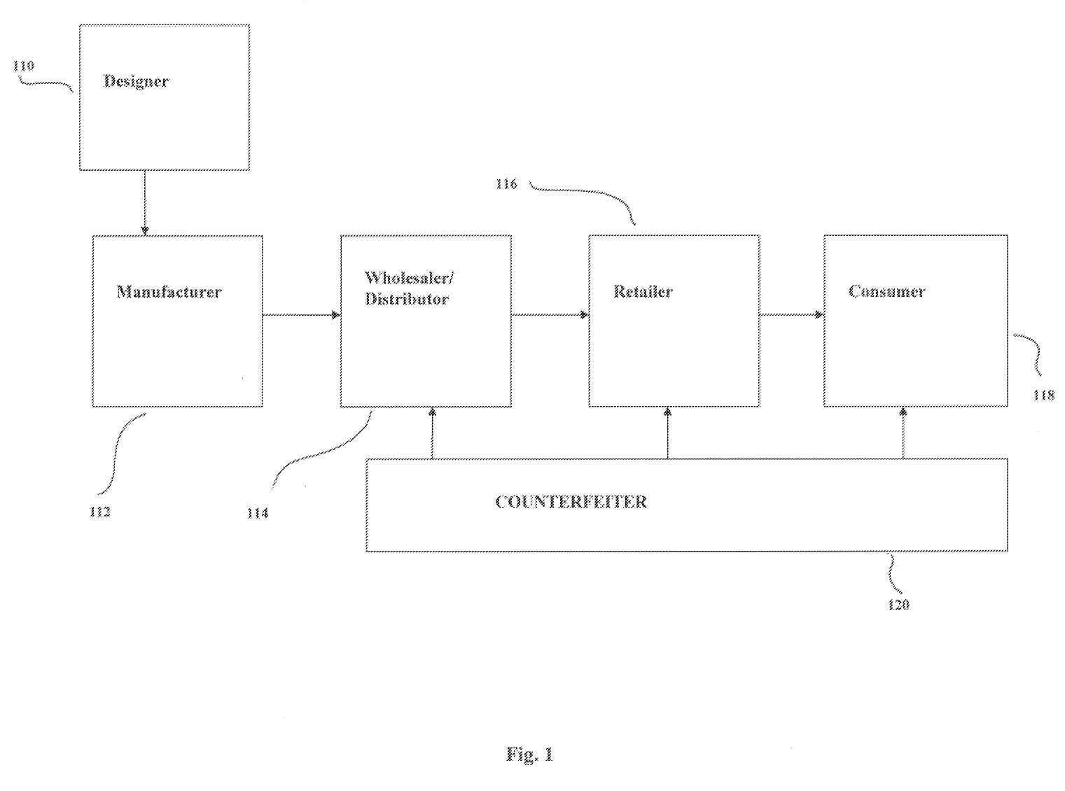

Referring now to FIG. 1, an example supply chain for a product is shown. The first step in the supply chain is the designer 110. The designer designs the product. This is the first and most creative step in the process of creating any product. The market generally believes that the designer, as the most creative individual in the process, should receive most of the benefit of the purchase of a product. The next step is the manufacturer 112. The manufacturer 112 may be the same as the designer 110. In many modern product companies, the designer 110 and the manufacturer 112 are not the same company. The manufacturer is typically a contractor for hire to manufacturer various types of goods for various designers 110. The manufacturer 112 enters into contracts to provide the goods as designed by the designer 110 to the designer's wholesaler/distributor 114.

Still referring to FIG. 1, the wholesaler/distributor 114 is the first person to receive the product as designed and manufactured. Typically, the wholesaler/distributor 114 receives huge volumes of the product for subsequent distribution to smaller retailers or even smaller and other wholesalers. In this example supply chain, the wholesaler/distributor 114 provides the goods to a retailer 116. In most supply chains, the wholesaler/distributor 114 provides the goods to numerous retailers throughout the country or world. Similarly, some of those retailers may also be sub-distributors with smaller regional distribution networks to other retailers. The typically model for a product from design to consumer has been simplified, but it is to be understood that this model may include many more steps and sub-step or several fewer. Modern designers often hire out manufacturing and provide their own retail outlets, thereby being the base of design and the base of sale for product. There are numerous other methods by which a product may be designed, manufactured and sold. FIG. 1 is only an exemplary option for use in explaining the method of this invention.

Still referring to FIG. 1, the retailer 116 then sells the product to a consumer 118. Also included in this figure is the counterfeiter 120. As can be seen, the counterfeiter 120 may come into the process at any step along the way. For example, the counterfeiter 120 may provide product to the wholesaler/distributor 116 directly. In this situation, the counterfeiter would be posing as a manufacturer 112. Alternatively, as suggested above, the manufacture 112 of the legitimate goods may, in fact, be the same manufacturer of these counterfeit goods. In that case, the wholesaler/distributor 114 will have a very difficult time distinguishing between legitimate goods and counterfeit goods.

Still referring to FIG. 1, the counterfeiter 120 may also appear at the retail level, selling directly to a retailer 116. In this case, the counterfeiter poses as a wholesaler/distributor 114. In the more nefarious schemes, the retailer realizes while it is purchasing product that it is obviously not legitimate product, but does not care. In the unaware retailer scenario, the counterfeiter 120 may even be an otherwise-legitimate product distributor, but may also have a stock of counterfeit goods as well. The retailer 116 may be tricked or may go along with the sale of counterfeit goods knowingly, thus passing them on, eventually, to the consumer 118.

Finally, the counterfeiter 120 may enter the supply chain with direct access to the consumer 118. In this case, the counterfeiter is an integrated operation with manufacturing, distribution and retail all in one organization. These types of counterfeiting organizations are less likely, because they are more easily detected and counteracted through traditional legal means. But, in some cases, the counterfeiter sells directly to the consumer through their own means or group of distributors or retailers. In this situation the consumer 118 may or may not realize that the goods are counterfeit until after the purchase. Often they do realize that the goods are counterfeit, but do not care. The designer 110 does care, because the counterfeit sale diminishes the profits which would likely otherwise be seen by the designer 110. Other consumers wish to avoid a glut of counterfeits for some types of products so as to maintain the exclusive nature of having a legitimate product by a particular designer 110.

Also depicted in FIG. 1 is the final element of this supply chain, the added protection of direct designer 110 to consumer 118 communication. It should be obvious that the communication described herein need not be directly between the designer 110 and consumer 118. In fact, the communication may be between any of the parties visible in FIG. 1 and the consumer 118 or even between a third party responsible for product authenticity maintenance and the consumer 118. In the method of this invention, tags or other indicia of legitimate products are updated frequently so as to distinguish from counterfeit and non-counterfeit products. The communication can consist of the consumer 118 of a legitimate product submitting to the designer (or retailer or manufacturer) their name, address and the product purchased. The designer 110 then determines if the product is legitimate. Once the designer 110 determines that it is, the consumer 118 is given periodic updates to the tags that they use with their product. These tags are updated frequently enough to frustrate the purposes of counterfeiters to “pose” as the actual products, but infrequently enough to not require large expenditures on the part of the designer. Periodically, these tags are sent to the consumer 118. Furthermore, in an effort to offset the costs associated with the manufacture of the tags, the designer 110 may charge a small fee for the continued service of providing these tags to the consumer 118.

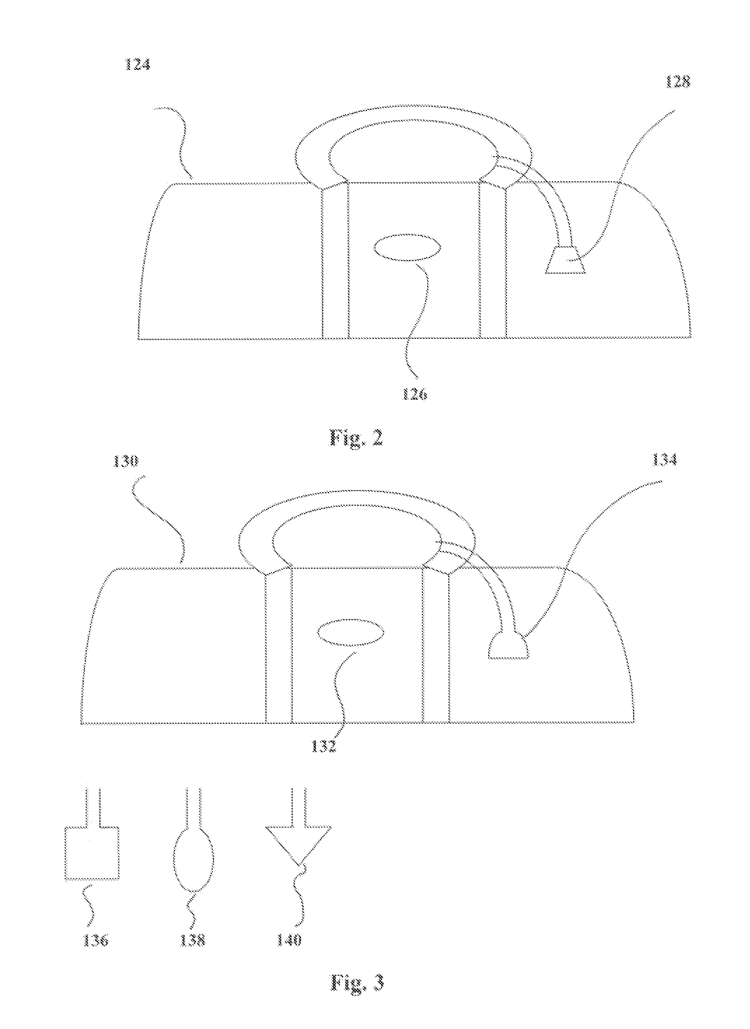

Referring now to FIG. 2, an example product is depicted. This example product is a purse 124. Designer purses are hugely popular and very expensive items designed to compliment various clothing. Designer purses, as a result, are one of the most often counterfeited products. A large percentage of the counterfeit products purchased in the United States are designer fashion products, including purses. The purse 124 is merely offered as an example of a product that is often counterfeited. There are numerous other products, including other fashion products, that are also counterfeited. It is to be understood that the method of this invention can be used with virtually any type of product that is susceptible to counterfeiting.

The purse 124 in FIG. 2 has two elements which are important for purposes of the present invention. The first is the designer label 126. The designer label 126 is a simple method to counteract counterfeiting. Because it is so simple, it has been relatively ineffective. In fact, recent news articles concerning counterfeiting discuss the importation of the nearly-complete counterfeits, without designer labels 126, then sewing the designer labels on once the product has cleared customs.

The designer label is usually the trademark of the company or the brand name used by the company accompanied by some decorative or fashionable embellishments. The designer label has proven to be a fairly ineffective deterrent to counterfeiting and has been improved upon with the inclusion of a designer tag 128. While serving substantially the same function and often looking substantially similar to the designer label 126, the designer tag 128 is often added after the product has been inspected by the designer and has passed through legitimate channels. This tag typically displays the company trademark or brand name trademark along with some decorative embellishments. However, this tag is “static” and can be easily copied or recreated by the counterfeiter along with the rest of the product. It is, therefore, an ineffective counterfeiting deterrent.

Referring now to FIG. 3, another purse 130, similar to the one in FIG. 2 is depicted. This purse 130 is also outfitted with a designer label 132 and a designer tag 134. However, using the method of this invention, this purse is also outfitted with a whole series of designer tags 134, 136, 138 and 140.

In one embodiment of the method of this invention, the first designer tag 134 would come along with the product. It would be added at the retail level by the retailer before the item goes on the shelve. In alternative embodiments, it may be added at the manufacturing level. Once the consumer purchases the product, both the retailer and the consumer send in a voucher form to the designer. This voucher form contains a serial number for the product. Once the designer has received the voucher form with the serial number of the product, the designer knows that the product has in fact been sold and that the individual who owns it is the person who sent in the other portion of the voucher. There may be various means employed whereby the designer may determine whether this voucher form itself has been tampered with or faked. They are beyond the scope of this invention.

Next, the designer then enters that consumer's name and address into their database of registered products. The database is subsequently used, a few months or weeks later to request manufacture of new designer tags, different from the previous designer tags, which will then be sent to the consumer for use with his or her product. The appearance of these tags on the bags, demonstrate to the consumer and to others that the product with the appropriate tags is a legitimate product and not a counterfeit. Furthermore, the designer may include the newly-altered tags in advertising or marketing campaigns to increase the awareness that a new tag is available and its new design.

Alternatively, the purchaser may become a registered user of the product directly at the point of sale. The retailer may provide the legitimate product with a legitimate first designer tag 134. The retailer would then register that a particular bag has been sold including the most recent first designer tag 136. Concurrently with this issuance, the retailer may, in one embodiment, issue a corresponding RFID tag to a purchaser. Subsequently, the purchaser would simply return to the retailer to validate prior purchases and would receive updated tags directly from the retailer. This embodiment has the advantage of providing additional foot-traffic to a retail store when the customer returns. If a purchaser of the good at a retailer and subsequently moves to a location where no corresponding retailer is available, the purchaser may utilize one of the alternative embodiments for receiving updated designer tags such as by mail to the manufacturer, retailer or other responsible third party.

The foregoing may be more readily understood by way of an example. Jane Doe purchases the purse 130 from a retailer. The purse contains the designer label 132 and the designer tag 134. The retailer sends Jane Doe's purchase information in, including her name and the address associated with her credit card. Also included in this information is a serial number or bar code which is associated with the particular purse 130 which Jane Doe has purchased. Substantially simultaneously, Jane Doe supplies her voucher to the designer, including the serial number or barcode and her name and address. The designer then enters the product associated with that serial number as “sold” into its database, including the owner as Jane Doe. Jane Doe may also begin paying a small fee to maintain her name in the database at this time, depending upon the designer's wishes

Several weeks later an updated designer tag 136 has been created by the designer to identify legitimate goods. The designer then mails out the designer tag 136 to all of the individuals in the database, including Jane Doe. Jane Doe then affixes the new designer tag 136 to her bag and discards (or keeps) the old designer tag 134. This occurs several times over the course of a year, each time Jane Doe affixing the new designer tag 138 or 140 as they arrive and discarding (or keeping) the old designer tags. Throughout all of this, Jane Doe is reassured that her bag is in fact legitimate and individuals who see Jane Doe with her purse know that she has a non counterfeit purse. Similarly, a retailer with legitimate merchandise in stock would periodically be issued new tags to replace the prior tags.

Still referring to FIG. 3, in one alternative embodiment, the purchaser of a purse could simply return to the retailer (See element 116 in FIG. 1) who would exchange the designer first designer tag 134 for a second designer tag 136 after sufficient proof of purchase or that the first designer tag 134 was in fact legitimate. Alternatively, an radio frequency identification (RFID) tag may be issued along with the sale of a valid purse 130. This RFID tag would include information such as a serial number or other identification that the purse 130 was in fact a legitimate sale. The purchaser then could return to the store, having the RFID tag scanned at predetermined intervals to receive the second designer tag 136.

Alternatively, the purchaser could return the RFID tag to the manufacturer in order to affect the issuance of a second designer tag 136, simply disposing or returning the first designer tag 134 subsequently. In this scenario, the manufacturer (see FIG. 1) would then return the valid RFID tag or issue a new RFID tag. RFID tags are very inexpensive to manufacture and are capable of unique identification of a product. In yet another alternative embodiment, the first designer tag 134 may include an RFID tag embedded within it, whereby a user could return with the purse, be issued a second designer tag 136 with a new embedded RFID tag, demonstrating that the purse is not counterfeit in a visible way.

This process could be managed by any one of the parties depicted in FIG. 1, such as the designer 110, the manufacturer 112, the wholesaler/distributor 114 or the retailer 116. Alternatively, the process of providing updates to the designer tag 128 (see FIG. 2) may be licensed or otherwise provided by a legitimate third-party. In this scenario, any of the embodiments above would be undertaken and managed by a third party company or individual responsible for ensuring that the legitimate goods who desire updated designer tags receive them and for ensuring that the process is secure.

The counterfeiter in any of the alternative embodiments is not as fortunate. As the tags continue to update, the counterfeiter must attempt to keep up. He must request manufacture of the tags from his sources, then provide them along with each of his products. By the time the majority of these products reach the market, the tag is nearly ready to be changed again. About the time he reaches the market, the tags are changed and the designer, manufacturer, retailer or other licensed party provides the new tags to Jane Doe (and other legitimate purchasers). The counterfeit goods are readily recognizable by wholesalers, retailers and consumers as counterfeit for failing to have the newest tags affixed. The legitimate retailers would have continuously updated designer tags, while the counterfeiters would have one-generation-ago designer tags affixed.

This process, no matter who is responsible for securing it, ensures that there is a readily changeable, visually distinctive, attachable ever-changing designer tag which has a limited time-duration and establishes a visual link in an ongoing chain of authenticity, both to the consumer and to the manufacturer or designer of the product. The method of this invention utilizes this chain to ensure on-going security with regard to authentic goods long after they have left the hands of the designer or manufacturer of the goods. This further reassures that consumers of the goods typically susceptible to counterfeiting receive the full benefit of the purchase as well.

This provides the dual benefit of demonstrating to consumers and retailers that the products are counterfeit and of removing the perceived benefit of getting a counterfeit designer good for a substantially lower price. The counterfeit good would be immediately recognizable as counterfeit and individuals would rather have the original or something different than something readily recognizable as counterfeit. This removes the benefit of having look-alikes if they are now obviously distinguishable from the authentic goods. Furthermore, the method of this invention discourages counterfeit designer tag production, as they are easily distinguished from legitimate designer tags that are often updated.

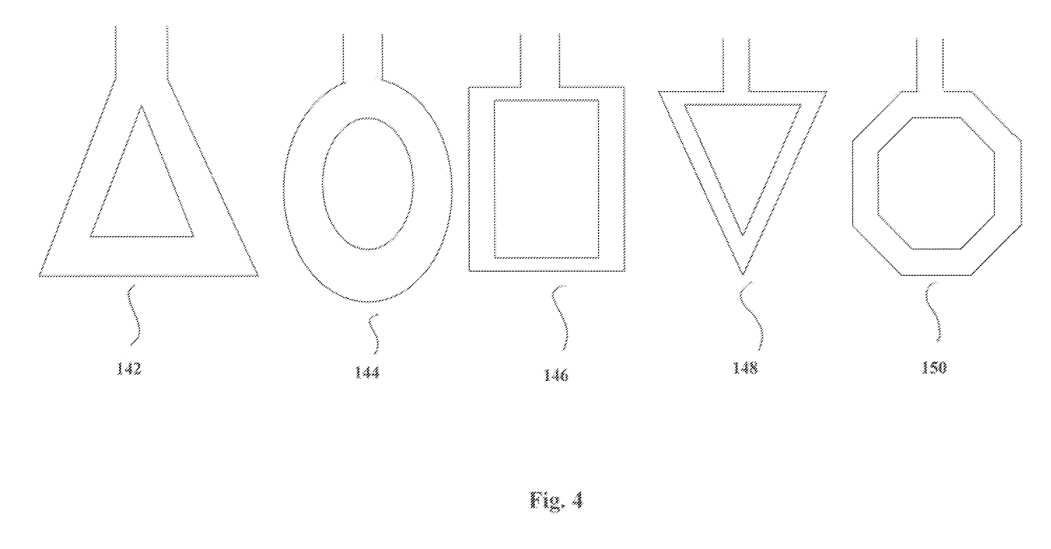

Referring next to FIG. 4, several example designer tags are shown. Any number of different tags may be used. The tags depicted in this figure are used only for exemplary purposes. Tags may be differentiated by such things as shape, size, material, and surface design. There is a triangular designer tag 142, a circular designer tag 144, a rectangular designer tag 146, an upside-down triangular tag 148 and an octagonal designer tag 150. It is further to be understood that the designer tags may be in any shape, color or size. The newest designer tag may be bright teal and be spherical in shape or decahedronal. There is no limit to the types of shapes, colors and size combinations that the designer tags may employ. This is beneficial because it keeps counterfeiters from guessing which type of tag will be next.

The alternating and often-updated designer tags of varying shapes, sizes, materials and colors may be used in print, video, web and other media to distinguish counterfeit goods from authentic goods. The designer tags of non-counterfeit goods may be used to further establish brand identity for particular brands. In order to provide consumer awareness of the current authentic designer tag, various media may be employed in order to advertise the type of designer tag that is current.

In order to avoid counterfeiting initially, the designer may request that the bags be made in one factory, while the first issue of designer tags be made in another. That way the products are never together until they are purchased or reach retailers. The designer could then only affix the tags at their discretion after a review of the quality of the goods and after receiving them all. Subsequent designer tags may be made in yet another factory or by another manufacturer to ensure that the current product manufacturer does not know what the current designer tags look like and is thus not tempted to counterfeit.

In an alternative embodiment, the designer tags may include an RFID (radio frequency identification) chip. This chip could be used to carry the serial number or registration number of the bag. It could be used as a further indicator of the legitimacy of the bag. This RFID tag may be incorporated into the design of the designer tag. It would be essentially invisible to the human inspector, internal to the tag. However, using an RFID activating frequency, one could quickly determine the serial number of the product and whether it was legitimate.

It will be apparent to those skilled in the art that the present invention may be practiced without these specifically enumerated details and that the preferred embodiment can be modified so as to provide additional or alternative capabilities. The foregoing description is for illustrative purposes only, and that various changes and modifications can be made to the present invention without departing from the overall spirit and scope of the present invention. The present invention is limited only by the following claims.

What is claimed is:

1. A method for deterring the manufacture, sale or distribution of counterfeit consumer goods comprising the steps of:
(a) selling a product including at least one indicator of authenticity;
(b) providing an update to said at least one indicator of authenticity for said product.

2. The method of claim 1, wherein said providing step is repeated at least once.

3. The method of claim 1, wherein said at least one indicator of authenticity is a visually identifiable tag to be attached to said product.

4. The method of claim 1, wherein said at least one indicator of authenticity is a radio frequency identification to be attached to said product.

5. The method of claim 1, comprising the additional step of advertising said product including representations of said update to said at least one indicator of authenticity.

6. A method for deterring the manufacture, sale or distribution of counterfeit consumer goods comprising the steps of:
(a) associating a first indicator of authenticity with a product;
(b) distributing said product and said associated first indicator of authenticity to a consumer;
(c) providing a second indicator of authenticity to said consumer;
(d) publicizing said second indicator of authenticity; and
(e) repeating said providing and said publicizing steps at pre-determined time intervals.

7. The method of claim 6 wherein each of said indicators of authenticity are adapted to be coupled to said product.

8. The method of claim 6 wherein each of said indicators of authenticity are visually distinguishable from each other.

9. The method of claim 6 wherein each of indicators of authenticity include a radio-frequency ID (RFID) tag.

10. The method of claim 6 further comprising, substantially simultaneous with said distributing step, the step of obtaining contact information from said consumer.

11. A method for deterring the manufacture, sale or distribution of counterfeit consumer goods comprising the steps of:
(a) associating a first indicator of authenticity with a product;
(b) distributing said product and said associated first indicator to a consumer;
(c) obtaining contact information from said consumer;
(d) providing a second indicatory of authenticity to said consumer at a location specified by said contact information,
wherein said first and second indicator of authenticity may be detachably coupled to said product and are visually distinguishable from each other;
(e) publicizing said second indicia of authenticity; and
(f) repeating said providing and said publicizing steps at a pre-determined time interval.

12. The method of claim 11, wherein each of said indicators of authenticity include a radio-frequency ID tag.

13. The method of claim 11, wherein step (c) if performed substantially simultaneously with said step (b).

14. The method of claim 11, wherein said pre-determined time interval is at least one month.
